(19) United States
(12) Patent Application Publication
(10) Pub. No.: US 2020/0329344 A1
(43) Pub. Date: Oct. 15, 2020

(54) LOCALIZATION AND TRACKING METHOD AND MULTI-POINT COMMUNICATION SYSTEM

(71) Applicant: Shou-Kuan Tsai, New Taipei City (TW)

(72) Inventor: Shou-Kuan Tsai, New Taipei City (TW)

(21) Appl. No.: 16/842,193

(22) Filed: Apr. 7, 2020

(30) Foreign Application Priority Data
Apr. 9, 2019 (TW) 108112385

(51) Int. Cl. H04W 4/029; H04W 4/80

(52) U.S. Cl. CPC H04W 4/029; H04W 84/18; H04W 4/80

(57) ABSTRACT

A multi-point communication system includes movable node devices that communicate with each other via first communication paths to result in a mesh network, the node device requiring no positioning receiver; and mobile communication devices that communicate with corresponding node devices via second communication paths. The node device includes a first communication protocol and a different second communication protocol. The node devices share data by transferring the data to and from each other.

### CROSS-REFERENCE TO RELATED APPLICATIONS

This application claims priority to Taiwan Patent Application No. 108112385, filed on Apr. 9, 2019, the entire contents of which are herein expressly incorporated by reference.

### BACKGROUND OF THE INVENTION

### 1. Field of the Invention

The present invention generally relates to a multi-point communication system, and more particularly to a localization and tracking method.

### 2. Description of Related Art

Zigbee, an IEEE 802.15.4-based specification, is a wireless communication protocol of low-power, low-bandwidth and low data rate. Due to its short effective transmission distance of hundreds of meters, Zigbee is primarily used to create small-scale personal area networks adaptable to applications such as home automation or Internet of things (IoT).

The global positioning system (GPS) is a satellite-based radio navigation system capable of providing localization data to a GPS receiver. However, the GPS signal is weak in general, and may suffer reception failure when blocked by obstacles such as buildings.

Most modern mobile devices, such as mobile phones, are equipped with a GPS receiver, which helps the user to obtain localization data instantly. GPS may be adapted to localization and tracking applications, in which a tracked object (e.g., vehicle, human or animal) is equipped with a GPS receiver, which receives localization data that is then transferred to a remote tracker via a wireless network such as broadband mobile network. However, the broadband mobile network is expensive and may be unavailable in remote districts.

A need has thus arisen to propose a novel localization and tracking scheme to improve drawbacks of the conventional localization and tracking systems.

### SUMMARY OF THE INVENTION

In view of the foregoing, it is an object of the embodiment of the present invention to provide a multi-point communication system capable of performing instant localization and tracking at a lower cost without being blocked due to environmental factors.

According to one embodiment, a multi-point communication system includes a plurality of movable node devices and a plurality of mobile communication devices. The node devices communicate with each other via first communication paths to result in a mesh network, the node device requiring no positioning receiver. The communication devices communicate with corresponding node devices via second communication paths. The node device includes a first communication protocol and a second communication protocol, the second communication protocol being different from the first communication protocol, communication being performed via the first communication path with the first communication protocol, and communication being performed via the second communication path with the second communication protocol. The node devices share data by transferring the data to and from each other.

According to another embodiment, a localization and tracking method includes the following steps: providing a plurality of movable node devices and a plurality of mobile communication devices; one node device obtaining localization data of a tracked object from a corresponding communication device; transferring the localization data to another node device; and a tracking communication device obtaining the localization data of the tracked object from a corresponding node device.

### BRIEF DESCRIPTION OF THE DRAWINGS

FIG. 1 shows a system block diagram illustrating a multi-point communication system according to one embodiment of the present invention;

FIG. 2 shows a detailed block diagram exemplifying the node devices and the communication devices of FIG. 1;

FIG. 3 shows a system block diagram illustrating a localization and tracking system according to one embodiment of the present invention;

FIG. 4 shows a flow diagram illustrating a localization and tracking method according to one embodiment of the present invention;

FIG. 5 shows another system block diagram illustrating a localization and tracking system according to one embodiment of the present invention; and

FIG. 6 shows another flow diagram illustrating a localization and tracking method according to one embodiment of the present invention.

### DETAILED DESCRIPTION OF THE INVENTION

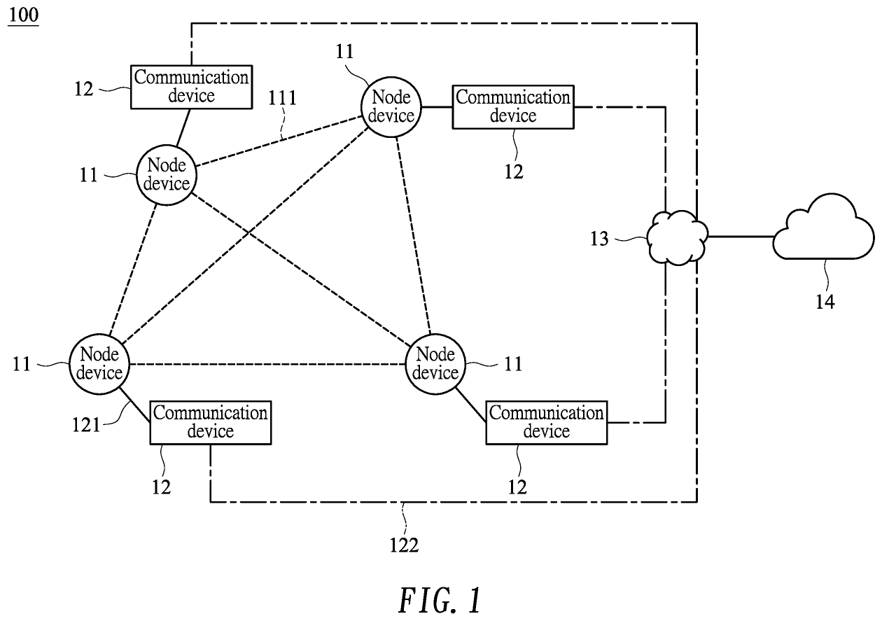

FIG. 1 shows a system block diagram illustrating a multi-point communication system 100 according to one embodiment of the present invention. The multi-point communication system 100 may include a plurality of movable node devices 11 that communicate with each other via wireless first communication paths 111 to result in a mesh or multi-point network. Specifically, each node device 11 may communicate with one or more node devices 11. In one embodiment, the node device 11 may include a Zigbee device such as Zigbee chip or module. In another embodiment, however, the node device 11 may adopt a (current or future) communication protocol (e.g., Z-wave) being similar to Zigbee. Generally speaking, the embodiment may adopt a low-power wide-area network (LPWAN) that, for example, uses a Long Range (LoRa) technology.

The multi-point communication system 100 may include a plurality of mobile communication devices 12 (e.g., mobile phones, computers or tablet computers) that communicate with corresponding node devices 11 via wired or wireless second communication paths 121. In the embodiment, “corresponding” indicates that the communication device 12 is within an effective transmission distance of the node device 11, and the communication device 12 therefore may access data to or from the node device 11. As exemplified in FIG. 1, the communication devices 12 may communicate with Internet 13 via third communication paths 122, and may further access a cloud database 14 via the Internet 13.

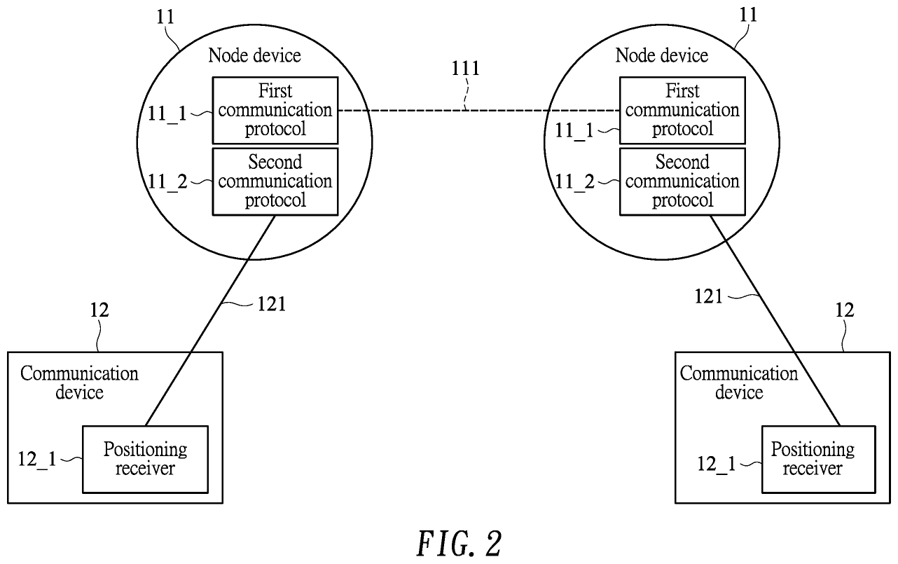

According to one aspect of the embodiment, the node device 11 may include a plurality of different communication protocols for communicating with other node devices 11 and the communication devices 12 respectively. FIG. 2 shows a detailed block diagram exemplifying the node devices 11 and the communication devices 12 of FIG. 1. Specifically, the node device 11 may include a first communication protocol (e.g., Zigbee communication protocol) 11_1 and a second communication protocol (e.g., Bluetooth, Wi-Fi and/or universal serial bus (USB) communication protocol) 11_2, and the second communication protocol 11_2 is different from the first communication protocol 11_1. In one embodiment, the node device 11 requires no positioning receiver, but the communication device 12 may include a positioning receiver 12_1, such as global positioning system (GPS) receiver, configured to receive localization data.

In the embodiment, the node devices 11 may communicate with each other via the first communication path 111 with the first communication protocol (e.g., Zigbee) 11_1, and the communication device 12 may communicate with corresponding node device 11 via the second communication path 121 with the second communication protocol (e.g., Bluetooth, Wi-Fi or USB) 11_2.

According to another aspect of the embodiment, the node devices 11 may share data (e.g., GPS localization data, temperature, altitude or humidity) by transferring the data to and from each other. Accordingly, the node device 11 may be used as a communication (or interaction) interface between the communication devices 12, such that the communication devices 12 may transfer required data to and from each other.

Further, the communication devices 12 may upload data to the Internet 13 via third communication paths 122, and the data may then be stored in the cloud database 14. The communication devices 12 may receive required data from the Internet 13 via third communication paths 122. Accordingly, data sharing in the multi-point communication system 100 may be achieved.

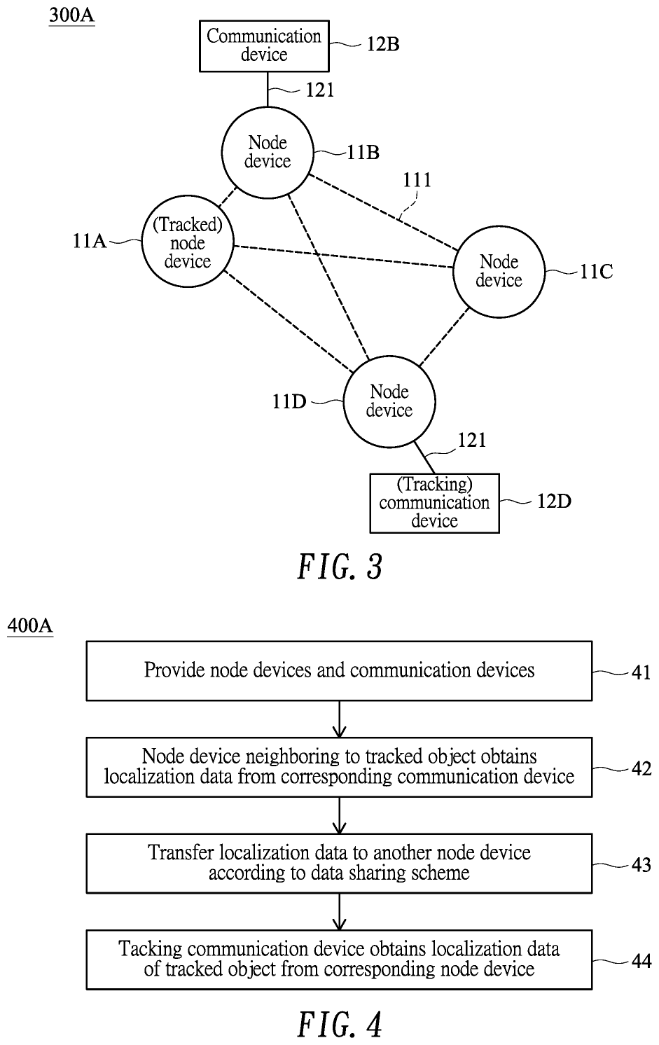

FIG. 3 shows a system block diagram illustrating a localization and tracking system 300A according to one embodiment of the present invention, and FIG. 4 shows a flow diagram illustrating a localization and tracking method 400A according to one embodiment of the present invention. The architecture of the localization and tracking system 300A of the embodiment is similar to the multi-point communication system 100 of FIG. 1, and the same numerals and symbols are used. The localization and tracking system 300A may include a plurality of movable node devices (e.g., the node devices 11A, 11B, 11C and 11D as shown) and a plurality of mobile communication devices 12 (step 41). Specifically, the node device 11A to be tracked may be disposed on a tracked object such as vehicle, human or animal.

As shown in FIG. 3, in step 42, the node device 11B is neighboring to the tracked node device 11A, and the node device 11B may obtain localization data (e.g., GPS localization data) from corresponding communication device 12B via the second communication path 121 with the second communication protocol (e.g., Bluetooth, Wi-Fi or USB) 11_2. As the tracked node device 11A is neighboring to the node device 11B (and the communication device 12B), the tracked node device 11A is disposed at substantially the same position as the neighboring node device 11B (and the communication device 12B).

Next, in step 43, according to the data sharing scheme as stated above, the localization data may be, directly or indirectly, transferred to another node device (e.g., node device 11D associated with the tracker) via the first communication path(s) 111 with the first communication protocol (e.g., Zigbee) 11_1.

In step 44, when the tracking communication device 12D is within the effective transmission distance of the node device 11D, the communication device 12D may obtain the localization data of the tracked object via the second communication path 121 with the second communication protocol (e.g., Bluetooth, Wi-Fi or USB) 11_2, thereby knowing the location of the tracked object according to the localization data.

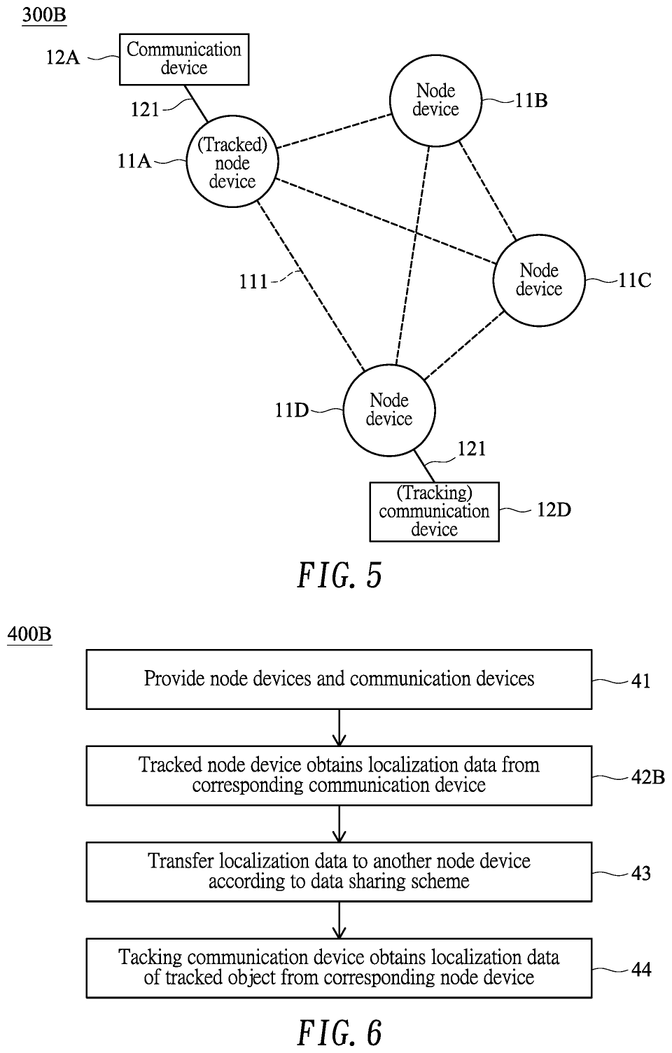

FIG. 5 shows another system block diagram illustrating a localization and tracking system 300B according to one embodiment of the present invention, and FIG. 6 shows another flow diagram illustrating a localization and tracking method 400B according to one embodiment of the present invention. The localization and tracking system 300B of FIG. 5 is similar to the localization and tracking system 300A of FIG. 3, except that the tracked node device 11A is not neighboring to the node device 11B. In step 42B, when the tracking communication device 12A is within the effective transmission distance of the tracked node device 11A, the communication device 12A may transfer localization data (e.g., GPS localization data) to the corresponding node device 11A via the second communication path 121 with the second communication protocol (e.g., Bluetooth, Wi-Fi or USB) 11_2.

Next, in step 43, according to the data sharing scheme as stated above, the localization data may be, directly or indirectly, transferred to another node device (e.g., node device 11D associated with the tracker) via the first communication path(s) 111 with the first communication protocol (e.g., Zigbee) 11_1.

In step 44, when the tracking communication device 12D is within the effective transmission distance of the node device 11D, the communication device 12D may obtain the localization data of the tracked object via the second communication path 121 with the second communication protocol (e.g., Bluetooth, Wi-Fi or USB) 11_2, thereby knowing the location of the tracked object according to the localization data.

In another embodiment, the location of the tracked node device 11A as shown in FIG. 5 may be obtained via conventional triangulation method and/or signal intensity range finding method.

Although specific embodiments have been illustrated and described, it will be appreciated by those skilled in the art that various modifications may be made without departing from the scope of the present invention, which is intended to be limited solely by the appended claims.

What is claimed is:

1. A multi-point communication system, comprising:
a plurality of movable node devices that communicate with each other via first communication paths to result in a mesh network, the node device requiring no positioning receiver; and
a plurality of mobile communication devices that communicate with corresponding node devices via second communication paths;
wherein the node device includes a first communication protocol and a second communication protocol, the second communication protocol being different from the first communication protocol, communication being performed via the first communication path with the first communication protocol, and communication being performed via the second communication path with the second communication protocol;
wherein the node devices share data by transferring the data to and from each other.

2. The system of claim 1, wherein the node device adopts low-power wide-area network (LPWAN).

3. The system of claim 1, wherein the communication device comprises a mobile phone, a computer or a tablet computer.

4. The system of claim 1, further comprising Internet, with which the communication device communicates via a third communication path.

5. The system of claim 1, wherein the first communication protocol comprises low-power wide-area network (LPWAN) communication protocol, and the second communication protocol comprises Bluetooth, Wi-Fi or universal serial bus (USB) communication protocol.

6. The system of claim 1, wherein the data shared by the node devices comprises global positioning system (GPS) localization data, temperature, altitude or humidity.

7. A localization and tracking method, comprising:
(a) providing a plurality of movable node devices and a plurality of mobile communication devices;
(b) one node device obtaining localization data of a tracked object from a corresponding communication device;
(c) transferring the localization data to another node device; and
(d) a tracking communication device obtaining the localization data of the tracked object from a corresponding node device.

8. The method of claim 7, wherein the step (b) comprises:
a node device neighboring to the tracked object obtaining the localization data from a corresponding communication device.

9. The method of claim 7, wherein the step (b) comprises:
when a communication device is in an effective transmission distance of a node device associated with the tracked object, said communication device transferring the localization data to the node device associated with the tracked object.

10. The method of claim 7, wherein the node device comprises Zigbee device.

11. The method of claim 7, wherein the communication device comprises a mobile phone, a computer or a tablet computer.

12. The method of claim 7, wherein the localization data comprises global positioning system (GPS) localization data.

13. The method of claim 7, wherein the node devices communicate with each other via wireless first communication paths to result in a mesh network, and the communication devices communicate with corresponding node devices via second communication paths.

14. The method of claim 13, wherein the node device comprises a first communication protocol and a second communication protocol, the second communication protocol being different from the first communication protocol, communication being performed via the first communication path with the first communication protocol, and communication being performed via the second communication path with the second communication protocol.

15. The method of claim 14, wherein the first communication protocol comprises low-power wide-area network (LPWAN) communication protocol, and the second communication protocol comprises Bluetooth, Wi-Fi or universal serial bus (USB) communication protocol.
